(19) United States
(12) Patent Application Publication
(10) Pub. No.: US 2026/0047589 A1
(43) Pub. Date: Feb. 19, 2026

(54) FROZEN NUTRITIONAL BEVERAGES AND RELATED METHODS

(71) Applicants: Dan Cardinal, Big Lake, MN (US); Beth Cardinal, Big Lake, MN (US)

(72) Inventors: Dan Cardinal, Big Lake, MN (US); Beth Cardinal, Big Lake, MN (US)

(21) Appl. No.: 19/367,319

(22) Filed: Oct. 23, 2025

Related U.S. Application Data
(62) Division of application No. 16/448,870, filed on Jun. 21, 2019.
(60) Provisional application No. 62/690,026, filed on Jun. 26, 2018.

(51) Int. Cl. A23L 2/02; A23L 19/00; A23L 33/105

(52) U.S. Cl. CPC A23L 2/02; A23L 19/09; A23L 33/105; A23V 2002/00; A23V 2300/20

(57) ABSTRACT

Described are nutritional beverages, including frozen nutritional beverages made using frozen particles that contain fruit or vegetable constituent, and diluted (fluid) nutritional beverages containing the frozen particles and liquid; also described are relate methods of preparing, storing, and consuming the frozen nutritional beverages and the diluted nutritional beverages.

### FIELD OF THE INVENTION

The following description relates to nutritional beverages, for example frozen nutritional beverages and diluted nutritional beverages derived from the frozen nutritional beverages;

methods of making nutritional beverages, including frozen and diluted or “fluid” nutritional beverages; and methods of storing and consuming nutritional beverages.

### BACKGROUND

Chilled or frozen beverages that contain fruit, vegetables, or both as primary ingredients, for example beverages referred to as “smoothies,” (generally referred herein to as “nutritional beverages”) are popular as fast and healthy snacks or nutritional drinks. A smoothie is made using fruit or vegetables as a base ingredient, often in combination with other ingredients such as a dairy ingredient (e.g., yogurt), vitamins or other nutritional additives (protein), and ice. A typical smoothie drink contains a creamy dairy product such as milk, cream, or yogurt, along with ice, blended fruit, vegetable, or juice. Other ingredients such as vitamins or concentrated protein may also be added, as well as optional sweetener. A smoothie is usually thick, similar in thickness to a milkshake, and is served cold.

Smoothies are often prepared and sold in a commercial setting such as at a kiosk, food or sandwich shop, food court, or even at an exercise facility or health club. In this type of commercial setting a smoothie is made immediately before being consumed. The ingredients are combined in a blender and the blender mixes the ingredients together to form a thick, smooth, chilled, and preferably cold beverage. The chilled, blended beverage then is poured into a glass or cup and consumed through a straw, by using a spoon, or by drinking directly from the glass or cup.

Smoothies can also be prepared in a home kitchen using the same ingredients and a blender. But preparing a single smoothie at home is not overly convenient or efficient because home preparation requires a supply of the ingredients, the blender, and cleaning the blender after each use.

Other nutritional drinks, i.e., “juices,” are sold as refrigerated or frozen juice products at grocery stores and health food stores. These juice drinks may contain fruit and vegetable ingredients, and may additionally include vitamin, protein, and dairy product (milk, cream, yogurt, etc.) additives. Some juice products are sold in refrigerated or frozen consumer-sized package for storage in a home refrigerator or freezer. Some juice products can be consumed directly from the package. Other products may be concentrated, and may be prepared and then consumed by removing the juice from the package in which the juice is sold, followed by thawing and combining with other ingredients (e.g., water) if necessary.

Juice products, however, can have certain shortcomings such as a failure to provide full nutrition from fruits or vegetables, or by containing artificial sweetener, preservatives, or other additives that are not as nutritional as pure vegetable or fruit constituents. Many juice products contain only a portion of the total nutritive content of a fruit or vegetable. For example, juices are commonly prepared using fruits or vegetables from which pulp has been removed. Many juices also contain artificial sweeteners or preservatives. And, many refrigerated juice products are heat-processed to extend refrigerated storage stability, such as by pasteurizing or otherwise sterilizing. Heat processing, however, can typically also reduce the nutritive and flavor properties of the juice, and will also de-activate natural enzymes. Overall, most or all juice products lack much of the original organic and nutritive content of a fruit or vegetable; all or most of the pulp of a fruit or vegetable is normally removed during juicing, along with the skin (rind), and seeds.

### SUMMARY

Nutritional beverages are in high demand. Especially desirable are nutritional beverage products that are convenient to use and to consume, e.g., may be either pre-prepared or prepared without substantial need for equipment (e.g., a blender) or steps of measuring or combining multiple ingredients. Desired nutritional beverage products may also be highly nutritional, for example may contain most or all of the original materials of a fruit or vegetable, especially most or all of the naturally-occurring pulp and juice, optionally with active enzymes, and do not require protein or sweetener.

The Applicant has identified new and inventive nutritional beverages that contain a high amount of fruit, vegetables, or both. A nutritional beverage may be in the form of a frozen nutritional beverage that contains frozen particles that contain fruit, vegetable, or both, that can be diluted by combining the frozen particles with liquid to form a fluid nutritional beverage that can be consumed normally by drinking. When the frozen nutritional beverage is in the frozen state, e.g., in a container, and has not been combined with liquid for a dilution step, the beverage may be referred to as a “frozen (un-diluted) nutritional beverage.” The Applicant has also identified methods of preparing these frozen nutritional beverages, and methods of storing, shipping, preserving, marketing, and consuming (after a dilution step) these frozen nutritional beverages.

Also contemplated as part of the presently-described invention, the frozen nutritional beverage can be diluted by combining the frozen nutritional beverage with liquid to form a “diluted nutritional beverage,” which can also be referred to as a “fluid nutritional beverage.” As used herein the term “dilute” means to add liquid to a collection of frozen particles of a frozen nutritional beverage (to at least partially fill void space between the particles) so that the frozen particles partially or completely melt, dissolve, or both, within the liquid, and the resultant combination of the liquid and frozen nutritional beverage includes the frozen particles or partially frozen (partially melted) particles.

As used herein the phrase “void space,” when referring to a collection of frozen particles contained in a package, refers to the fraction of the volume within the collection that is open space (containing air) between the particles, relative to the total amount of space (volume) of the collection of particles. As an example, when referring to a container of one unit of volume filled (completely) with a collection of particles (the collection of particles including the particles and spaces between the particles that contains air), the total amount of volume of the space between the particles (the space in the container not taken up by the particles) is referred to as the “void space.” The amount of void space in the collection of particles may be described as a percent of the total volume (e.g., “xx” percent) of the collection of particles. The space taken up by the particles (not including void space) of a collection of particles is equal to 100 percent, minus the void space: void space (percent) +space taken by individual particles (percent)=100 (percent). For a substance that is a solid, there is no void space, i.e., the void space equals zero.

Void space particularly refers to spaces or openings between particles in a collection of particles, which is different from and does not include “headspace” of a container, which is a space between a collection of particles and an interior surface of a container. Headspace in a container that contains food refers to empty interior space present between an interior surface of the container, and food contents within the container.

As described herein, liquid can be added to void space between particles of a frozen nutritional beverage contained in a container. The liquid (e.g., cold water) can at least partially fill the void space and optionally fill a portion or all of the headspace. The liquid will melt or partially melt the frozen particles fairly rapidly to change the form of the frozen nutritional beverage from a collection of frozen particles into a thick, chilled (e.g., partially frozen) diluted nutritional beverage, i.e., a “fluid beverage” that can be consumed by drinking normally as a beverage such as through a straw or directly from a container.

In one aspect the invention relates to a frozen nutritional beverage product that includes frozen particles in a container with void space between the particles. The frozen particles comprise, consist of, or consist essentially of frozen fruit constituent, frozen vegetable constituent, or both. The frozen particles can be converted to a fluid nutritional beverage by adding liquid to the container to at least partially fill the void space.

In another aspect the invention relates to a method of preparing a frozen nutritional beverage product that contains (comprises, consists of, or consists essentially of) frozen particles having void space between the particles. The frozen particles include (comprise, consist of, or consist essentially of) frozen fruit particles, frozen vegetable particles, or both, wherein the frozen particles can be converted to a fluid beverage by adding liquid to the container to fill the void space. The method includes (comprises, consists of, or consists essentially of): freezing one or more fruit constituents, one or more vegetable constituents, or a combination of one or more fruit constituents and one or more vegetable constituents; forming the frozen particles; and placing the frozen particles in a container with void space between the frozen particles.

In yet another aspect the invention relates to a method of preparing a fluid nutritional beverage product from a frozen nutritional beverage product. The frozen nutritional beverage product includes frozen particles in a container with void space between the particles, the frozen particles comprising frozen fruit constituents, frozen vegetable constituents, or both. The method includes: adding liquid to the frozen nutritional beverage to at least partially fill the void space.

### BRIEF DESCRIPTION OF THE FIGURES

FIGS. 1A and 1B show raw fruit constituents being combined in a blender.

FIGS. 2A and 2B show a blended combination of raw fruit constituents being frozen to a frozen combination.

FIG. 3 shows a step of forming particles using an ice shaving machine.

FIG. 4 shows an example of a frozen nutritional beverage product that includes frozen particles in a container.

### DETAILED DESCRIPTION

Described as follows are new and inventive nutritional beverages that contain significant amounts of fruit, vegetables, or both, with preferred nutritional beverages containing fruit or vegetable constituents that are raw, meaning uncooked and not heat processed. In one form a nutritional beverage may be what is referred to herein as a “frozen nutritional beverage” (a.k.a., a “non-diluted nutritional beverage,”). The frozen nutritional beverage includes (comprises, consists of, or consists essentially of) a collection of a large number of frozen pieces or “particles” that contain fruit, vegetable, or both, and that are held in a frozen state with voidspace between the particles, e.g., within a container. The particles can be held in a container that can be used for one or more of: containing the frozen particles (the frozen nutritional beverage) immediately after preparation, transport, storage, sale, and consumption of the beverage. The frozen nutritional beverage can be held (stored) at a low (frozen) temperature so that the particles remain frozen, then diluted and consumed.

In one useful embodiment the frozen nutritional beverage can be held, frozen, in a container into which the frozen nutritional beverage is placed at a time (e.g., soon) after preparation of the frozen nutritional beverage (in frozen particle form) from one or more fruits or vegetables. Optionally the same container may be used for storing and transporting the frozen nutritional beverage for sale as well as for displaying the frozen nutritional beverage for sale. The container may be eventually used for diluting the contained frozen nutritional beverage, and consuming the dilute nutritional beverage.

The container may have an interior volume that is suitable for a single serving or for multiple servings of the nutritional beverage. An example container may have an interior volume of less than 1 gallon, e.g., less than a half-gallon, less than a quart, or less than a pint. Particular examples may be in a range from 10 to 35 fluid ounces, e.g., from 12 to 30 fluid ounces. The container may be clear (transparent) or may include a clear portion or panel to allow viewing of the contents. The container may be suitable for holding and storing a frozen nutritional beverage as described at a frozen temperature, e.g., below 32, 15, or 0 degrees Fahrenheit, for a time period required to transport a product from a place of production (plant) to a place of sale or consumption; for example for a time of up to 3, 10, 20, or 30 days, or even up to 100 days. The container may include a cover that covers an opening and minimizes spillage that may occur during shaking. The opening may be used for introducing for a straw or spoon, for pouring a fluid nutritional beverage into a consumers mouth, or for sipping the fluid nutritional beverage from the container. A cover may be a replaceable cap such as a screw off, twist off, snap-on cap, or the like.

The collection of frozen particles can be in the form of many particles that are contained together in a single space or container with contact between the particles, but also with spaces present between the particles, and with the particles being moveable relative to one another. The spaces can be referred to as “void space” that is made of the sum of all space present between particles in a collection, e.g., with the collection of particles contained by a container. The frozen nutritional beverage in this form includes the particles in frozen form with substantially no liquid (e.g., with no added liquid). The frozen nutritional beverage made of these frozen particles is not in a condition for normal consumption as a beverage, i.e., for “drinking” by a consumer. While the frozen nutritional beverage could be consumed in this frozen form, as frozen particles, the present invention and the following description contemplate a step of diluting the frozen nutritional beverage by adding liquid to the frozen nutritional beverage to convert the frozen nutritional beverage into a chilled (e.g., partially frozen) beverage that may be consumed normally by drinking, as a “fluid beverage.”

The frozen particles of the frozen nutritional beverage, and more generally the frozen nutritional beverage, may contain, consist of, or consist essentially of fruit constituent, vegetable constituent, or a combination of these, optionally in combination with one or more of a nut constituent, a herb constituent, a grain constituent, or another natural plant constituent (see listing of examples of nuts, herb, and edible plant materials below, considered to be nut or plant constituents). Other optional ingredients, which may be included but are not necessary, including sweeteners (natural or non-natural, e.g., honey), oils, vinegars, honey, roots, grain constituents (e.g., whole grains), nuts, seeds, herbs, legumes, weeds, flowers, fermented foods, animal products (e.g., dairy or protein).

For purposes of the present description, “fruit constituent” is naturally occurring material of fruit, including pulp, juice, naturally occurring and present vitamins or minerals or other matter dissolved in the juice, peel, skin, rind, seeds, stems, leaves, roots, or the like. A nutritional beverage as described may include fruit constituent that includes many, much, or all of these materials of a fruit, with none being removed (no removal of pulp, seeds, leaves, or peel), or with some selected portions (e.g., root, seeds, peel, leaves) being removed. Example fruit constituents can include at least 90 or 95 percent by weight of an original amount of pulp and juice of a fruit.

Similarly, for purposes of the present description, “vegetable constituent” is naturally occurring material of a vegetable, including pulp, juice, naturally occurring and present vitamins or minerals or other matter dissolved in the juice, peel, skin, rind, seeds, stems, leaves, roots, or the like. A nutritional beverage as described may include vegetable constituent that includes many, much, or all of these materials of a vegetable, with none being removed (no removal of pulp, seeds, leaves, or peel), or with some selected portions (e.g., root, seeds, peel, leaves) being removed. Example vegetable constituents can include at least 90 or 95 percent by weight of an original amount of pulp and juice of a vegetable.

As used herein, the phrase “consists essentially of” (and related forms of the phrase such as “consisting essentially of”), when used to refer to a composition or a combination of specified ingredients, refers to a composition or combination of ingredients that contains the stated composition or combination of ingredients and not more than an small or insubstantial amount of any other ingredient, e.g., not more than 5, 3, 2, 1, 0.5, or 0.1 weight percent of other ingredients or materials. A frozen nutritional beverage that consists essentially of fruit constituent, vegetable constituent, or a combination of these, e.g., in the form of frozen particles made from fruit constituent, vegetable constituent, or a combination of these, contains the fruit constituent, vegetable constituent, or a combination thereof, and not more than 5, 3, 2, 1, 0.5, or 0.1 weight percent of other ingredients or materials.

When the frozen nutritional beverage is in a frozen state, optionally and preferably in a container, and has not been combined with liquid during a dilution step, the beverage may be referred to as a “frozen (un-diluted) nutritional beverage.” In this state, the frozen nutritional beverage contains frozen particles that are in contact with each other, and that are also separated by void space present between the particles. The sizes of the frozen particles, and the amount of the void space (the amount of space between the particles and not taken up by the particles) can in combination be sufficient to allow for the frozen nutritional beverage to be combined with liquid (e.g., water, juice, tea, milk, etc.), i.e., diluted, to form a diluted nutritional beverage that can be consumed normally by drinking. This means, for example, that when liquid such as water (e.g., cold water) is added to a frozen nutritional beverage held in a container, in an amount that fills (partially, substantially, or completely) the void space, the liquid will melt or partially melt the frozen particles fairly rapidly to change the form of the frozen nutritional beverage from a collection of frozen particles into a thick, chilled (e.g., partially frozen) diluted nutritional beverage (referred to as a “fluid beverage”) that can be consumed by drinking through a straw or by sipping or pouring directly from a container to a user's mouth. In presently useful examples, a frozen nutritional beverage, upon adding cold water (e.g., water at a temperature of 45 degrees Fahrenheit) to fill the total amount of void space present between the particles (and without the need for any additional mixing, blending, shaking or other type of agitation) can become a diluted nutritional beverage that is capable of being consumed by drinking through a straw or directly from a container in an amount of time that is less than 20 minutes, 10 minutes, e.g., less than 5, 4, 3, or 2 minutes.

The sizes of the particles can be relatively small, such as the size of frozen pieces prepared by a method of shaving frozen fruit or vegetable constituent. The particles are desirably small enough to allow the particles to melt or dissolve within a relatively short time, as described, when liquid is added to the voidspace between particles, especially so that the diluted nutritional beverage may be consumed by drinking through a straw or directly from a container within less than 20, 10, 5, 4, 3, or 2 minutes. Examples of useful particles sizes (average, within a collection) may be sizes that are less than 5 millimeters, e.g., less than 3 millimeters. The particles, when considered as a collection with voidspace between the particles, may or may not contain discernible (e.g., visible to an unaided eye) pieces, “particles” or “chunks” of frozen material, depending on the size, consistency, or uniformity of the particles. A collection of particles may be considered to be a “slushy” composition, such as a composition of small particles or shavings that is not a solid, but that may be caused to flow or move relative to each other and that contain void space as described.

When the collection of particles is contained in a container (preferably a container that can be used to store an transport the frozen nutritional beverage, and to eventually dilute the nutritional beverage, and consume the diluted nutritional beverage), the collection of frozen particles can preferably contain void space between the particles that will allow for an amount of liquid to be added to the container so that the liquid will dilute the frozen nutritional beverage to form a diluted nutritional beverage that can be consumed by drinking through a straw or directly from a container in an amount of time that is less than 20 or 10 minutes, e.g., less than 5, 4, 3, or 2 minutes. Example amounts of void space between particles of the collection can be below 60 percent, e.g., in a range from 5 to 40 percent or from 10 to 35 percent. Optionally, a small amount of headspace (space between particles and a wall of a container, usually at a top portion of a container) may also be present in the container, e.g., less than 20, 15, or 10 percent headspace; during a dilution step the liquid may be also, optionally, added to the headspace or a portion of the headspace.

The frozen nutritional beverage in the form of a collection of frozen particles can be changed into the diluted nutritional beverage in the form of a partially frozen, partially melted, partially liquid beverage, for normal consumption as a beverage (by drinking), by being combined with (“diluted” with) liquid. The diluted nutritional beverage (“fluid beverage”) can be a smoothie or a smoothie-like drink that contains pieces of chilled, frozen, or partially frozen (partially melted) particles as described; the particles contain vegetable constituent, fruit constituent, or both, optionally along with ice or frozen juice, and are suspended within the liquid. The diluted nutritional beverage may be consumed by any of a variety of techniques for consuming a liquid beverage such as a smoothie or other thick beverage, e.g., by pouring the beverage from a container into a user's mouth, by sipping the beverage directly from a container, or by using a spoon or a straw to remove the diluted nutritional beverage from a container.

The diluted nutritional beverage can comprise, consist of, or consist essentially of the liquid used in a dilution step, and the frozen particles of the frozen nutritional beverage, with the particles being in a frozen, partially frozen, or melted or partially melted state.

The liquid may be any desired liquid, such as water, milk, tea (e.g. green tea, kombcha), or juice. A juice can be made of natural ingredients obtained from a fruit, or vegetable. Examples of juices are peach, pear, blackberry, cranberry, apple, grape, orange, lemon, tomato, spinach, and the like. Many other juice types whether in the form of a puree, concentrate, can also be used, depending upon the desired end flavor. Other example liquids may include: non-alcoholic drinks, barley, coconut milk or coconut water, caffeinated coffee, chocolate, energy drinks, fermented drinks, juice drinks, probiotic drinks, rice drinks, root beer, soft drinks, sparkling water, alkaline water, alcoholic drinks. While other ingredients may be added, example and preferred diluted nutritional beverages as described do not require any ingredient other than the liquid and the frozen nutritional beverage.

Optionally and preferably, a step of diluting a frozen nutritional beverage can be performed within a container that is also used to contain the frozen nutritional beverage during one or more of preparing, transporting, storing (e.g., in a commercial, retail, or home freezer), marketing (presenting for sale), or selling the frozen nutritional beverage. In an example dilution step, liquid can be added directly to this type of container to fill void space and optional headspace that is present in the container along with the frozen particles of the frozen nutritional beverage. Not accounting for headspace, if any, in the container, the relative amount of liquid added to the container that contains the frozen nutritional beverage (in particle form) can be up to about 75 percent, e.g., in a range from 10, 20, or 25, up to 40, 50, or 60 percent of the volume of the collection of frozen particles in the container, i.e., the amount of liquid may approximate the void space of the collection of frozen particles contained in the container. Alternately stated, in terms of the volume of a container that contains the frozen particles and optionally some amount of headspace above the frozen particles, e.g., the amount of headspace being less than 20, 15, or 10 percent of the total volume of the container, the amount of liquid added to the container that contains the frozen nutritional beverage and optional headspace can be up to about 70 percent, e.g., in a range from 10, 20, or 25, up to 40, 50, or 60 percent of the total interior volume of the container.

A diluted nutritional beverage as described may be different from a reconstituted fruit juice e.g., reconstituted orange, grape, or apple juice, etc., prepared by adding water to a fruit juice concentrate, and may be different from other types of nutritional beverages (other smoothies), based on one or more features of the diluted nutritional beverage. For example, a diluted nutritional beverage may contain a higher percentage of solids (meaning non-water fruit or vegetable constituents) than a reconstituted fruit juice. A diluted nutritional beverage may contain frozen or partially frozen particles that contain fruit or vegetable constituents, and may contain higher amounts of seeds, rind, peel, or pulp, as compared to many fruit juice products. A diluted nutritional beverage as described may also, optionally, contain only, or essentially only, fruit constituents, vegetable constituents, or a combination of these (optionally with other natural ingredients such as nut constituent, grain constituent, herb, etc.), to the exclusion of added ingredients such as one or more of: added dairy ingredient, added protein ingredient (e.g., concentrated protein ingredient), added vitamins or minerals, added sugar or other sweetener, etc.

With respect to solids (i.e., non-water ingredients), a diluted nutritional beverage may contain at least 25, 40, 50, 60, 75, weight percent non-water ingredients, meaning non-water fruit constituents or non-water vegetable constituents, including pulp, naturally occurring vitamins or minerals, peel, skin, rind, seeds, stems, leaves, roots, or the like; the diluted nutritional beverage may contain from 25 to 75 weight percent water, e.g., from 40 to 60 weight percent water.

In terms of fruit and vegetable constituents, including both non-water constituents and naturally-present water in a fruit or vegetable, a diluted nutritional beverage may contain at least 60, 75, 80, 85, or 90 percent fruit constituents or vegetable constituents including pulp, naturally occurring vitamins or minerals, juice (including water) peel, skin, rind, seeds, stems, leaves, roots, or the like.

The diluted nutritional beverage can include: the vegetable constituents or fruit constituents of the frozen nutritional beverage, the liquid used in a dilution step (e.g., water, milk, tea, cream, or juice), and does not require and may optionally exclude any other ingredients, e.g., may contain no added sugar, preservative, concentrated protein, or other dairy ingredient such as yogurt. Example diluted nutritional beverages can consist of or consist essentially of the vegetable constituents, fruit constituents, or combination thereof, of the frozen nutritional beverage, and the liquid used in a dilution step (e.g., water, milk, tea, cream, or juice).

The Applicant has also identified novel and inventive methods for preparing a frozen nutritional beverage as described, containing a collection of the frozen particles with voidspace between the particles. According to example methods, a frozen nutritional beverage can be prepared by steps that include: freezing fruit constituents, vegetable constituents, or both (with any other optional ingredients); combining the fruit constituents, vegetable constituents, or both (with any other optional ingredients), either before or after a freezing step; and forming the fruit constituents, vegetable constituents, or both (and any optional ingredients), into frozen particles, either before or after freezing or combining. An example method includes a freezing step, a combining (e.g., blending) step (either before or after the freezing step), and, after both freezing and combining, forming the frozen and combined (e.g., blended) constituents into frozen particles that contain the fruit constituents, vegetable constituents, or both (along with any optional ingredients).

Steps of freezing and combining fruit or vegetable constituents can involve any useful steps and techniques that produce a frozen blend, mixture, or combination of these constituents, which may be in the form of particles, or subsequently formed into particles. The constituents that are combined, frozen, and formed into particles, can comprise, consist of, consist essentially of fruit constituents, vegetable constituents, or a combination both fruit constituents and vegetable constituents. The constituents also may preferably include most of the entire amount of each of the fruit or vegetable pieces (especially pulp and juice) used to prepare the combination and frozen particles, meaning that the constituents include at least all or mostly all (at least 90 or 95 weight percent) of the pulp and juice from fruits or vegetables used to form the combination or mixture of the constituents. In certain examples, peels of a fruit or vegetable (e.g., apple, fruit, grapes, pears, or carrot), seeds, or other non-pulp and non-juice components can be included in the constituents to form the combination. Preferred steps include forming the frozen particles from constituents that are raw, non-previously-frozen, non-heat processed fruits or vegetables that include (at least) all or substantially all of the pulp and juice of the fruit or vegetable pieces used, meaning, for example, that the steps of forming the frozen particles from raw fruit or vegetables do not include any heating step and do not include any step of deliberately removing juice or pulp.

The constituents are preferably fresh (not previously frozen) and have not been heat treated to a substantial degree, such as by cooking, pasteurizing, or by any other heat or sterilization step that would cause any significant degree of degradation of the flavor or nutritive value of the constituents, such as by degrading or denaturing any naturally-occurring enzymes of the fruit or vegetable constituents. Example constituents have been frozen, or blended and then frozen, directly from a fresh (preferably not previously frozen) piece of fruit or vegetable, and have not been heat treated, e.g., heated to a temperature that would be used for a pasteurization or other sterilization process, e.g., have not been exposed to or held at a temperature above of 150 or 200 degrees Fahrenheit for a time sufficient to sterilize, pasteurize, or otherwise kill or eliminate microbes or bacteria from the constituents, or to cause degradation or denaturing of naturally-occurring enzymes in the constituent.

Still, while non-previously frozen and non-heat-processed constituents may sometimes be desired or preferred, the invention also contemplates the optional use of other types of fruit or vegetable constituents, or additional ingredients, including those that may have been pasteurized, high-pressure processed, cooked, cold-pressed, etc., if desired. Any one or more of ingredients may be raw, partially raw, pasteurized, fresh, frozen (i.e., previously frozen), whole or part, crushed, powder, dried, liquid, thermally processed, high-pressure processed, or pressed form.

In specific examples of steps of preparing a frozen nutritional beverage as described, fruit constituents, vegetable constituents, or both, may be assembled and optionally cut into pieces. Pieces may be as chunks, pellets, cubes, flakes, etc., of a size suitable for processing in a blender. Preferred constituents can include all or substantially all of the pulp portion and juice portion of multiple pieces of one or more fruits, one or more vegetables, or a combination of these. After blending, and after forming into frozen particles, the blended constituents can optionally and preferably include amounts of pulp and juice that correspond to the amounts of pulp and juice originally present in the one or more fruits, one or more vegetables, or in a combination of one or more fruits and one or more vegetables (or at least 90 or 95 percent of the originally present amounts). The order of combining, cutting, freezing, and forming particles of the constituents is not necessarily important. Fruit and vegetables can be cut, combined, e.g., blended, frozen, and formed into particles as a combination of fruits and vegetables, or different fruits or vegetables may be separately cut, blended, frozen, and eventually combined with other frozen fruit or vegetable constituents.

To form the frozen particles, any equipment that is effective to form frozen particles as described can be used, e.g., a mold or any machine or equipment that is effective to mechanically form frozen particles from a larger frozen piece, e.g., a pulverizer, press, blender, grinder, knife or other cutting machine, ice shaving machine, etc. To shave frozen particles from larger pieces of frozen constituents, an example of a useful piece of equipment is a PACOJET™ “blender” machine. Other ice shaving machines, chipping machines, flaking machines, or the like, may also be used.

After forming the frozen particles, the frozen particles can be placed into a container, which is preferably a container in which the frozen nutritional beverage may be stored, transported, and sold (if applicable), and then diluted within the same container. The container can contain one or multiple combinations of fruit or vegetable constituents, or frozen particles, either mixed or unmixed. For example, a container may be transparent and may contain multiple layers of different-colored frozen particles.

The ingredients and materials used for making a frozen nutritional beverage, e.g., within a container, are known and commercially available. These include fresh fruits and vegetables, (e.g. raw, non-heat processed), and known and commercially available blending and freezing equipment. Any blender may be used for combining or blending the fruit substituents, vegetable substituents, or combinations of these, along with any optional ingredients. For example, commercial grade blenders, which may have motors that exceed 2 hp or are rated between 1100-1560 watts, may be used. Commercial blenders manufactured by Viamix™, Waring™, and Blendtec™, may be suitable.

When a user is ready to consume the frozen nutritional beverage product, the user adds at least one liquid into the container holding the frozen particles and may optionally agitate the container, e.g., by manually shaking the container, to produce a drinkable fluid beverage. The added liquid may be any temperature, e.g., cold (e.g., from about −4° to 5°) or room temperature (e.g., 20° C. to 30° C.).

Referring to the figures, illustrated are example steps for preparing a frozen nutritional beverage as described, comprising, consisting of, or consisting essentially of fruit constituents, vegetable constituents, or both.

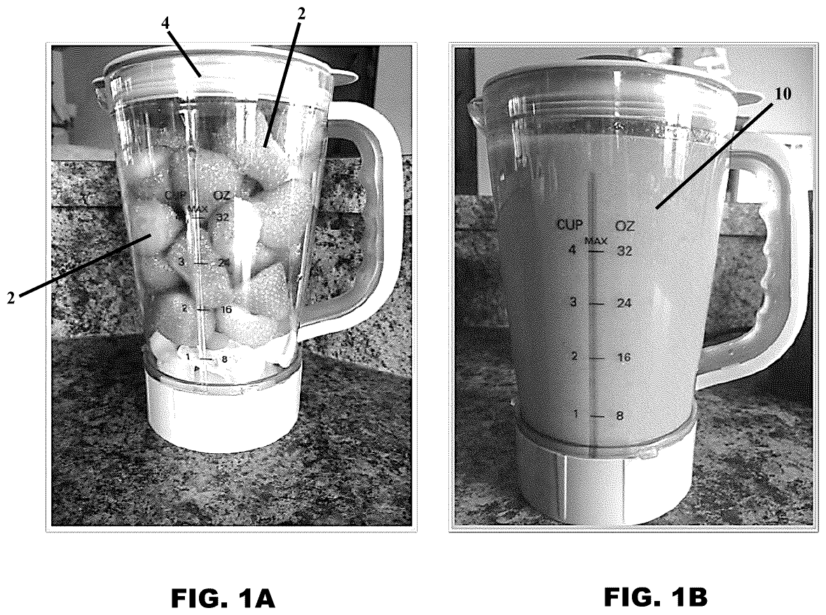

FIGS. 1A and 1B illustrate a step of combining fruit constituents 2. In the figure, a blender 4 is used to combine raw fruit constituents 2 that consist of raw, non-heat-processed, not-previously frozen, and non-frozen strawberries. Other raw (not-previously frozen, non-heat-processed) fruits or vegetables can also be included with the strawberries. As illustrated, ice or water may also, optionally, be included with the fruit or vegetable constituents. Water may be added, in particular, if one or more of the constituents is relatively dense, such as if a constituent is a beet, ginger root, or carrot. No other ingredient is added, but ingredients such as sweetener, yogurt, juice, protein, may optionally be added. In FIG. 1A the fruit constituents 2, in pieces, with ice, are in the blender before blending. FIG. 1B shows the blended (non-frozen) combination 10.

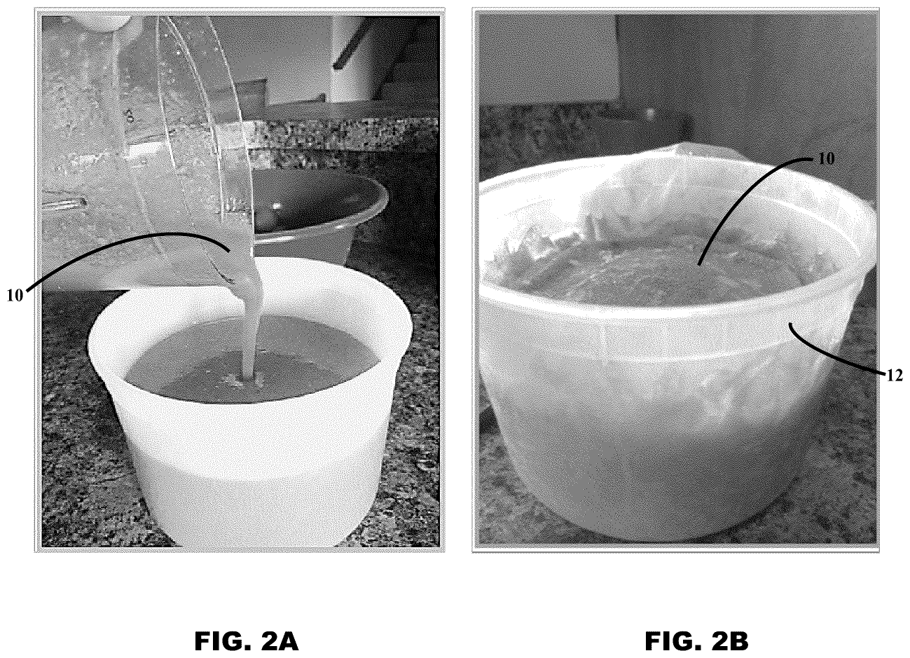

FIGS. 2A and 2B show a freezing step of freezing the blended combination 10 of FIG. 1B. At FIG. 1A blended combination 10, which is not frozen, is poured into container 12. The blended combination 10 in container 12 is then frozen (e.g., at a temperature that is below 32 degrees Fahrenheit, e.g., below 10, zero, or −5 degrees Fahrenheit). The frozen blended combination 10 in container 12 is shown at FIG. 2B.

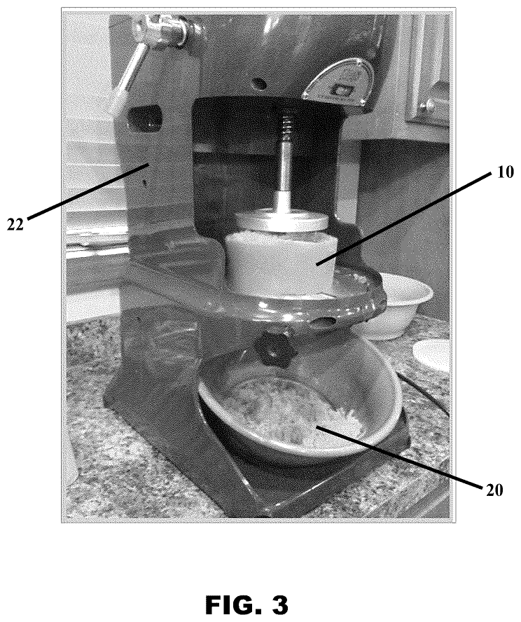

FIG. 3 illustrates a step of forming frozen particles 20 from the frozen blended combination 10 of FIG. 2B by using an ice shaving machine 22.

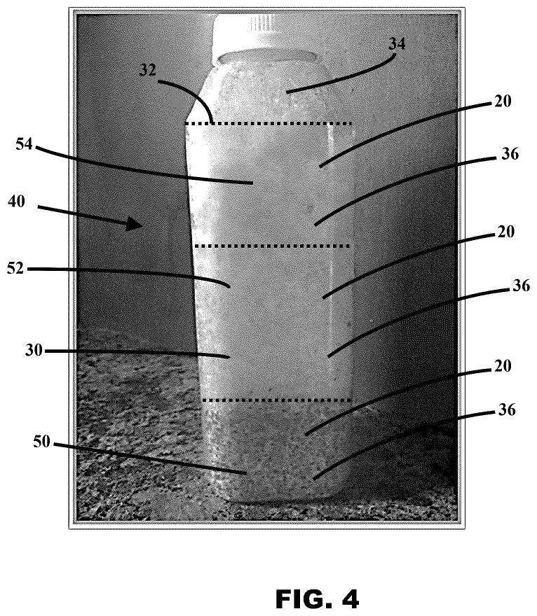

After forming frozen particles 20, frozen particles 20 are placed in a container, such as clear plastic container 30 of FIG. 4 to form frozen nutritional beverage product 40 of frozen particles 20 contained in container 30. The frozen particles fill a majority or substantially all of the internal volume of container 30 (e.g., approximately up to line 32), with empty headspace 34 present inside of container 30, above frozen particles 20. Void space 36 is present between frozen particles 20. In use, cap 38 can be removed from container 30 and liquid (e.g., water, not shown) can be added to container 30 through an upper (un-capped) opening in the container. The liquid can at least partially fill void space 36 and (optionally) headspace 34. The liquid (with optional replacement of cap 38 and shaking of container 30) will combine with frozen particles 20 to form a chilled, diluted, fluid nutritional beverage (e.g., “smoothie”) that can be consumed by a user through a straw or by pouring or sipping the fluid beverage from container 30 into the user's mouth.

Optionally, as illustrated at FIG. 4, frozen particles 20 can be arranged in multiple distinct portions or layers, each having a different color. Layers 50, 52, and 54 (separated by dashed lines) for example, are made of frozen particles 20 that are colored red, orange, and yellow, respectively.

Examples of plant and vegetable constituents useful in a nutritional drink of the present description (e.g., as the frozen particles, or in a diluted nutritional beverage) include those that are well known and commonly used in smoothies. A frozen or diluted nutritional beverage may include any fruit or vegetable constituent, as well as other food ingredients such as nuts oils, vinegars, honey (or other natural or synthetic sweetener), roots, grain constituent (e.g. whole grains), seeds, herbs, legumes, weeds, flowers, fermented foods, animal products (like dairy or protein). Some examples include the following.

### Bulb and Stem Vegetables

Asparagus, Cardoon, Celeriac, Celery, Chives, Elephant Garlic, Florence Fennel, Kohlrabi, Kurrat, Lemongrass, Leek, Lotus Root, Nopal, Onion, Pearl Onion, Potato Onion, Prussian Asparagus, Spring Onion/Scallion, Shallot, Tree Onion, Welsh Onion, Wild Leek, Manchurian Wild Rice, Root and Tuberous Vegetables, Ahipa, Arracacha, Bamboo Shoot, Beetroot, Burdock, Broadleaf Arrowhead, Camas, Canna, Carrot, Cassava, Chinese Artichoke, Daikon, Earthnut Pea, Elephant Foot Yam, Ensete, Galangal, Ginger, Hamburg Parsley, Horseradish, Jerusalem Artichoke, Jicama, Mashua, Parsnip, Pignut, Potato, Prairie Turnip, Radish, Rutabaga, Salsify, Scorzonera, Skirret, Swede, Sweet Potato, Taro, Ti, Tigernut, Turmeric, Turnip, Ulluco, Wasabi, Water Caltrop, Water Chestnut, Yacon, Yam

### Conditional Edibles

ArmLactarius Spp., anita Muscaria, Armanita Rubescens, Coprinopsis Atramentaria, Field Blewit, Gyromitra Esculenta, Morel, Tawny Grisette, Verpa Bohemica, Wood Blewit,

### Edible Fungi

Apricot Jelly, Bear's Head Tooth, Birch Polypore, Chaga, Chicken of the Woods, Comb Tooth Fungus, Common Morel, Dark Stalked Bolete, Dryad's Saddle, Giant Puffball, Late Fall Oyster, Lobster Mushroom, Old Man of the Woods, Oyster Mushroom, Pig's Ear, Reishi, Resinous Polypore, Scarlet Cup, Sidewalk Mushroom, Tinder Hoof, Turkey Tail, Velvet Shank

### Edible Weeds Grasses

Alfalfa, Arrowhead, Bearberry, Bilberry, Bitter Dock, Blue Vervain, Bluebead, Borage, Bracted Orache, Broadleaf, Bugleweed, Bull Thistle, Burdock, Catnip, Cattail, Chamomile, Chickweed, Chicory, Cleavers, Cloudberry, Coltsfoot, Common Hawthorn, Common Sow Thistle, Common Yarrow, Creeping Charlie, Crimson Clover, Crowberry, Crowfoot Grass, Daisy Fleabane, Dandelion, Downy Yellow Violet, Echinacea, Elderberry, Elecampagne, Evening Primrose, Eyebright, Fern Leaf Yarrow, Field Pennycress, Fireweed, Forget Me Not, Garlic Mustard, Goldenrod, Harebell, Henbit, Herb Robert, Hop Clover, Horehound, Horsetail, Horseweed, Japanese Knotweed, Joe Pye Weed Knapweed, Knotgrass, Kudzu, Labrador Tea, Lamb's Quarters, Lemongrass, Mallow, Marsh Marigold, Mayapple, Meadowsweet, Milk Thistle, Milkweed, Miner's Lettuce, Motherwort, Mugwort, Mullein, Nepal Dock, New England Aster, Oak Leaf Goosefoot, Oxeye Daisy, Palmer's Amaranth, Palmer's Amaranth, Partridgeberry, Pearly Everlasting, Peppergrass, Pickerelweed, Pigweed, Pineapple Weed, Prickly Pear, Purple Deadnettle, Purslane, Queen Annes Lace, Red Clover, Red Seeded Dandelion, Ribwort, Rue, Rugel's Plantain, Scarlet Pimpernel, Sea Lungwort, Sea Plantain, Sandwort, Self Heal, Sheep Sorrel, Shepherds Purse, Silverweed, Sow Thistle, Spiderwort, Spotted Dead Nettle, Spring Beauty, St. John's Wort, Stinging Nettle, Strawberry Blite, Sugar Cane, Sunflower, Supplejack Vine, Sweet Rocket, Sweet White Clover, Sweetfern, Tea Plant, Teasel, Thimbleberry, Timothy Grass, Tomcat Clover, Toothwort, Trout Lily, Valerian, Vervain Mallow, Watercress, Wheatgrass, White Trillium, Wild Bee Balm, Wild Grape Vine, Wild Violet, Wood Sorrel, Yellow Dock, Yellow Rocket, Yellow Toadflax, etc.

### Flowers and Buds

Artichoke, Borccoli, Borccolini Flowers, Bugleweed, Caper, Cauliflower, Coltsfoot, Courgette, Daylily, Loroco, Echinacea, Forget Me Not, Herb Robert, Honeysuckle, New England Aster, Spring Beauty, Squash Blossoms, St. John's Wort, Sunflower.

### Fruits

Apple, Apricot, Avocado, Banana, Bell Pepper, Bilberry, Bitter Gourd, Bitter Melon, Blackberry, Blackcurrant, Blueberry, Boysenberry, Buddha's Hand (fingered citron), Chayote, Crab Apples, Cucumber, Currant, Cherry, Cherimoya, Chico Fruit, Chili Pepper, Cloudberry, Coconut, Corn, Cranberry, Cucumber, Custard Apple, Damson, Date, Dragonfruit, Duria, Eggplant, Gonzoberry, Gooseberry, Grape, Grapefruit, Guava, Honeyberry, Huckleberry, Ivy Gourd, Jabuticaba, Jackfruit, Jambul, Jujube, Juniper Berry, Kantola, Kiwano (Horned Melon), Kiwifruit, Kumquat, Lemon, Lime, Loquat, Longan, Luffa, Lychee, Mango, Mangosteen, Marionberry, Melon (Bailan Melon, Canary Melon, Cantaloupe, Crenshaw Melon, Christmas Melon, Galia Melon, Hami Melon, Honeydew, Horned Melon, Korean Melon, Sprite Melon, Sugar Melon, Watermelon Winter Melon), Miracle Fruit, Mulberry, Nectarine, Nance, Olive, Olive Fruit, Orange(Blood Orange, Clementine, Mandarine, Tangerine) , Papaya, Passionfruit, Peach, Pea, Pear, Persimmon, Plantain, Plum, Pumpkin, Pineapple, Prune, Pineapple, Plumcot or Pluot, Pomegranate, Pemelo, Pumpkin, Purple Mangosteen, Quince, Raisin, Rambutan, Raspberry, Redcurrant, Salmonberry, Squash, Salal Berry, Salak, Satsuma, Soursop, Star Fruit, Strawberry, Sweet Pepper, Tamarand, Tamarillo, Tinda, Tomatillo, Tomato, Ugli Gruit, Vanilla, Watermelon, West Indian Gherkin, Winter Melon, Yuzu, Zucchini, etc,

### Grains and Ancient Grains

Amaranth, Barnyard Grass, Buckwheat, Chia, Enkorn, Kamut, Khorasan Wheat, Millet, Oat, Panicum, Quinoa, Sand Spur, Sorghum, Spelt, Teff, etc.

### Herbs and Spices

Ajwain, Akudjura, Alexanders, Alkanet, Alligator Pepper, Allspice, Angelica, Anise, Aniseed Myrtle, Annatto, Artemisia, Asafoetida, Avens, Barberry, Basil (Holy, Lemon, Thai, Sweet), Bay Leaf (Indian Bay Leaf), Boldo, Borage, Black Sesame Seed, Blue Fenugreek, Blue Melilot, California Bay Laurel, Caper, Chives, Cicely, Cilantro, Cinnamon (Ceylon, Indonesian, True, Saigon, White, Vietnamese), Myrtle, Clary, Clary Sage, Clove, Cocoa, Coriander Seed, Coriander (Vietnamese), Costmary, Cubeb Pepper, Cudweed, Culantro, Culangot, Cumin, Curry Leaf, Curry Plant, Dill herb weed or seed, Elderflower, Epazote, Fennel, Fenugreek, File Powder, Gumbo File, Fingerroot, Galangal (Cyperus Spp., Greater and Lesser), Garlic Chives, Ginger (torch, bunga siantan, Golpar, Grains of Paradise, Grains of Selim, Kani Pepper, Horseradish, Houttuynia Cordata, Huacatay, Hyssop, Indonesian Bay Leaf, Jasmine Flowers, Jakhya, Jiaogulan, Jimbu, Juniper Berry, Kaffir Lime Leaves, Makrud Lime Leaves, Kala Zeera, Kawakawa Seeds, Keluak, Kluwak, Kepayang, Kencur, Galangal, Kentjur, Kinh Gioi, Kokam Seed, Korarima, Koseret Leaves, Lavender, Lemon Balm, Lemon Ironbark, Lemon Myrtle, Lemon Thyme, Lemon Verbena, Lemongrass, Leptotes Bicolor, Lesser Calamint, Licorice, Lime Flower, Linden Flower, Lovage, Locust Beans, Mace, Mahleb, Marjoram, Mastic, Mint (All varieties), Mountain Horopito, Must Mallow, Mustard (Black, Brown, White, Yellow, plant and seeds), Nigella, Njangsa, Nutmed, Olida, Oregano, Cuban Oregano, Orris Root, Pandan Flower, Pandan Leaf, Paprika, Paracress, Parsley, Pepper (Black, Brazilian, Cornish pepper Leaf, Dorrigo, Green, Long, Mountain, Pink, White)Rosemary, Rue, Safflower, Saffron, Sage, Saigon Cinnamon, Salad Burnet, Salep, Sassafras, Sesame Seed, Savory (Summer and Winter), Sheep Sorrel, Shiso, Silphium, Sorrel, SpearTerragon, Thyme, Turmeric, Vanilla, Voatsiperifery, Wasabi, Water-pepper, Watercress, Wattleseed, Wild Thyme, Willow Herb, Wintergreen, Wood Avens, Woodruff, Wormwood, Yerba Buena, Yerba Mate, Yarrow, Za'atar, Zedoary

### Leafy and Salad Vegetables

Amaranth, Arugula, Beet (root and greens), Bok Choy/Pak Choy, Borage Greens, Broccoli (leaves and stalks), Brussel Sprouts, Cabbage, Catsear, Celery, Celtuce, Chaya, Chickweed, Chickory, Chinese Mallow, Garland Chrysanthemum, Collard Greens, Common Purslane, Corn Salad, Cress, Dandelion, Dill, Endive Fat Hen, Fiddlehead, Fluted Pumpkin, Garden Rocket, Golden Samphire, Good King Henry, Grape Leaves, Greater Plantain, Kai-lan, Kale, Komatsuna, Kuka, Lagos Bologi, Lamb's Lettuce, Lamb's Quarters, Land Cress, Lettuce, Lizard's Tail, Malabar Spinach, Mallow, Melokhia, Miner's Lettuce, Mizuna Greens, Mustard, Napa Cabbage, New Zealand Spinach, Orache, Pak Choy, Paracress, Pea (Sprouts and Leaves), Poke, Radicchio, Rapini (broccoli rabe), Samphire, Sculpit, Sea Beet, Sea Kale, Sierra Leone Bologi, Soko, Sorrel, Sour Cabbage, Spinach, Summer Purslane, Swiss Chard, Tatsoi, Turnip Greens, Watercress, Water Spinach, Wheatgrass, Yarrow, Yao Choy, Shepherd's Purse

### Nuts

Acorn, Almond, Beech, Black Walnut, Brazil Nut, Candlenut, Cashew, Chestnut (Chinese, Japanese, Sweet), Chilean Hazel, Colocynth, Egusi, Filbert, Hazelnut, Hickory, Kola Nut, Macadamia, Malabar Almond, Malabar Chestnut, Mamoncillo, Mongongo, Ogbono, Gourd, Paradise Nut, Pecan, Pepita, Pili, Pistachio, Shagbark Hickory, Ugu, Walnuts, Water Chestnut

### Pod Vegetables

American Groundnut, Azuki Beans, Black-Eyed Peas, Chickpea, Common Bean, Drumstick, Dolichos Bean, Fava Bean, Garbanzo, Green Bean, Guar, Horse Gram, Indian Pea, Lentil, Lima Bean, Moth Bean, Mung Bean, Okra, Pea, Peanut, Pigeon Pea, Ricebean, Snap Pea, Snow Pea, Soybean, Tarwi, Tepary Bean, Urad Bean, Velvet Bean, Winged Bean, Yardlong Bean

### Sea Vegetables

Aonori, Arame, Bladderwrack, Bulrush, Cattail, Carola, Carrageen Moss, Channelled Wrack, Chinese Water Chestnut, Chlorella, Chochayuyo, Dabberlocks (Badderlocks), Dulse (Dillisk), Ecklonia Cava, Eucheuma (Spinosum, Cottonii), Gelidiella, Gracilaria Edulis, Gracilaria Corticata, Grapestone, Gutweed, Hijiki, Hiromi, Hypnea, Irish Moss, Kelp, Kombu, Laver/Gim, LimuKala, Lotus, Mozuku, Nori, Oarweed, Ogonori, Rice, ) Sargassum (Cinetum, Vulgare, Swartzii, Myriocysum) Sea Grape, Sea Lettuce, Sea Palm, Sea Whip, Spiral Wrack, Sugar Kelp, Taro, Thongweed, Wakame, Watercress, Water Caltrop, Water Pepper, Water Spinach, Wasabi, Wild Rice

### Seeds

Adzuki Bean, African Rice, Amaranth, Amaranth Grain, Asian Rice, Bambara Groundnut, Barley, Barley Groat, Beach Bean, Black Gram, Breadnut, Broad Bean, Buckwheat, Buckwheat Groat, Cempedak, Chia, Chia Seed, Chickpea, Cocoa Bean, Coffee Bean, Common Bean, Common Purslane, Coolibah, Corn, Corn Kernel, Cowpea, Cycads, Durian, Durum, Durum Wheat, Fava Bean, Flax, Flaxseed, Fox Nut, Garbanzo Bean, Giant Waterlily, Ginkgo, Gnetum, Gram, Green Gram, Hanza, HempSeed, Indian Beechnut, Jackfruit, Juniper, Kamut, Kaniwa, Large Pigweed, Lentil, Lima Bean, Linseed, Lotus Seed, Maize, Mango Bark, Monkey-puzzle, Mung Bean, Nardoo, Oat, Oat Groat, Parakeelya, Pea, Peanut, Pine Nut, (Pinhao, Chilgoza, Korean, Mexican, Pinon, Single-leaf Pinyon, Stone Pine) Pitseed Goosefoot, Podocarps, Pomegranate Seed, Poppy Seed, Pumpkin Seed, Purple Pentatrope, Quinoa, Rye, Rye Berry, Sesame, Sesame Seed, Sorghum, Soybean, Spelt, Spelt Wheat, St. Thomas Bean, Sunflower Seed, Tammin Mallee, Watermelon Seed, Wheat, Wheat Berry, Wild Rice,

### Commercially Harvested Wild Edibles

Blewit, Boletus, Cantharellus Tubaeformis, Chanterelle, Clitocybe Nuda, False Moreln (Parboiled), Gypsy Mushroom, Hedgehog Mushroom, Hericium Coralloides, Horn of Plenty, Lion's Mane, Matsutake, Morel (Parboiled) Oyster Mushroom, Truffle (Bagnoli, Black Perigord Truffle, Black Summer, Borchi, Brumale, Chinese Black, Smooth Black

### Wild Edibles

Armillaria Mellea, Bay Bolete, Birch Bolete, Caesar's Mushroom, Cauliflower Mushroom, Chicken of the Woods, Coral Fungus Family, Corn Smut, Cortinarius Variicolor, Cyttaria Espinosae, Dryad's Saddle, Fairy Ring Champignon, Giant Puffball, Horse Mushroom, Hygrophorus Chrysodon, Lactarius Salmonicolor, Lactarius Volemus, Lycoperdon Caelatum, Mild Milkcap, Orange Milkcap, Ox Tongue, Parasol Mushroom, Pheasant's Back, Pine-spikes, Pinewood Mushroom, Polyporus Mylittae, Ramariaceae Species, Reishi, Rhizopogon Lutteolus, Russula, Scaber Stalk, Shaggy Inkcap (cooked) St. George's Mushroom, Suillus (Bovinus, Granulatus, Luteus, Tomentosus), Sulphur Shelf (Chicken Mushroom), Tricholoma Terreum, Velvet Shank

1-12. (canceled)

13. A method of preparing a nutritional beverage product, method comprising:
providing:
raw fruit constituent containing at least 90 weight percent pulp and juice of fruit, or
raw vegetable constituent containing at least 90 weight percent pulp or juice of vegetable, or
a combination of both;
blending the fruit constituent, vegetable constituent, or combination;
placing the blended fruit constituent, vegetable constituent, or combination, in a container;
freezing the blended fruit constituent, vegetable constituent, or combination, in the container to form a frozen piece;
forming frozen particles from the frozen piece by use of an ice shaving machine, the particles having an average size less than 5 millimeters;
placing the frozen particles in a container with void space between the frozen particles, and
adding liquid to the container, the liquid having a temperature in a range from 5 to 20 degrees Celsius.

14. (canceled)

15. A method of claim 13, wherein the container contains the frozen particles with from 10 to 60 percent void space between the frozen particles.

16. A method of claim 13, wherein the frozen particles in the container comprise at least 95 percent frozen particles consisting essentially of fruit constituent, frozen particles consisting essentially of vegetable constituent, or a combination thereof.

17. A method of claim 13, wherein the fruit constituent is not heat-treated and the vegetable constituent is not heat-treated.

18. A method of claim 13, wherein the container comprises at least one transparent sidewall.

19. A method of claim 13, wherein the container includes:
an interior defined by container walls and an upper opening,
headspace above the particles and below the upper opening of the interior, and
a replaceable cover at the upper opening,

20. A method of claim 13 comprising holding the frozen particles in the container at a temperature of below 32 degrees Fahrenheit for at least 3 days.

21. A method of claim 13, wherein the nutritional beverage product consists essentially of the frozen particles and the liquid.

22. A method of claim 13, the nutritional beverage product comprising the liquid and at least 95 percent fruit constituent, vegetable constituent, or a combination thereof.
